(19) United States
(12) Patent Application Publication
(10) Pub. No.: US 2007/0277364 A1
(43) Pub. Date: Dec. 6, 2007

(54) Method of fabricating an electronic module having a side contact

(75) Inventors: Liang-Jung Liu, Taipei Hsien (TW); Chih-Ching Chen, Taipei Hsien (TW)

Correspondence Address: BIRCH STEWART KOLASCH & BIRCH, PO BOX 747, FALLS CHURCH, VA, 22040-0747, US

(73) Assignee: Chicony Electronics Co. Ltd.

(21) Appl. No.: 11/727,374

(22) Filed: Mar. 26, 2007

(30) Foreign Application Priority Data
Jun. 2, 2006 (TW) 95119755

(51) Int. Cl. H01R 12/00

(52) U.S. Cl. 29/592.1; 439/66; 257/676; 29/832

(57) ABSTRACT

The present invention relates to a method of fabricating an electronic module having a side contact, at least comprising the steps of: providing a printed circuit board (PCB), with a first surface thereof having a first electrical contact as well as a second surface thereof forming a layout of a second electrical contact, such that the first electrical contact connects to the second electrical contact; providing an electronic actuator, having a pin thereof electrically connected to the first electrical contact on the first surface of the PCB; and bending an edge of at least one side of the PCB to the first surface, thereby forming an electronic module having a side contact through the layout of the second electrical contact.

### BACKGROUND OF THE INVENTION

1. Field of the Invention

The present invention relates to a method of fabricating an electronic module having a side contact, and more particularly to a method of enveloping an electronic actuator with a printed circuit board, and forming an electronic module having a side contact through a second electrical contact.

2. Description of the Related Art

Nowadays, people's living becomes more comfortable and convenient with the advent of diverse electronic products. The majority of these electronic products process to module integration with printed circuit boards (PCBs)

In the conventional PCB processing technology, PCBs are required to be first processed and then electrically connected to other modules or circuit loops. During PCB processing, PCB cutting produces dusts caused by the fracture and disintegration of fibers and resin materials on the circuit cross-sections. Therefore, product yield and quality are affected during the installation and processing of module components on the PCBs, and poor electrical effects are also produced at the electrical connections. For the existing PCB layout, the smaller the modules, the more the circuits per unit area, and the more complicated the circuits become. As a result, it is important to take circuit layout design of modules on the limited circuit board area into consideration.

Examples of typical applications are electronic modules of digital imaging machines. If dusts enter the package during fabrication, this causes localized shielding of optical transmission pathways, thereby causing imaging defects.

In summary, there are problems inherent in the conventional PCB processing technology. These problems include lowered product yield and product quality. As a result, extra manpower and equipment fees are required for fabrication, which contributes to increases in costs. Also, it is often a limiting factor for designing circuit layouts on the limited unit area of miniaturized modules. Consequently, improvement should be made to enhance the product yield, lower production costs and increase the space available for designing circuit layouts in the limited unit area so as to meet the needs of manufacturers.

### SUMMARY OF THE INVENTION

According to conventional PCB cutting process technology, dusts are produced by the fracture and disintegration of fibers and resin materials on the circuit cross-sections, product yield and quality will be affected during the installation and processing of module components on the PCBs, and poor electrical effects will be produced at the electrical connections. In the meanwhile, extra manpower and equipment fees required for fabrication will cause cost increasing, and furthermore, the smaller modules will be the limiting factor for designer to design the circuit layout of a limited unit area

To overcome the above drawbacks, the present invention provides a method of fabricating an electronic module having a side contact, at least comprising the steps of: providing a PCB, with a first surface thereof having a first electrical contact as well as a second surface thereof forming a layout of a second electrical contact, such that the first electrical contact connects to the second electrical contact; providing an electronic actuator, having a pin thereof electrically connected to the first electrical contact on the first surface of the PCB; and bending an edge of at least one side of the PCB to the first surface, thereby forming an electronic module having a side contact through the layout of the second electrical contact.

According to a more preferred embodiment of the present invention, the electronic actuator is an image chip.

According to another more preferred embodiment of the present invention, the PCB is a printed circuit board made of soft materials.

According to another more preferred embodiment of the present invention, the PCB is cross-shaped, and four sides of the PCB are bended to the first surface to envelop the electronic actuator, thereby an electronic module having a side contact will be formed through the layout of the second electrical contact.

According to another more preferred embodiment of the present invention, the PCB is T-shaped, and at least one side of said PCB is bended to the first surface, thereby an electronic module having a side contact will be formed through the layout of the second electrical contact.

According to another more preferred embodiment of the present invention, the PCB is L-shaped, and at least one side of said PCB is bended to the first surface, thereby an electronic module having a side contact will be formed through the layout of the second electrical contact.

The method of fabricating an electronic module having a side contact of the present invention provides the step of electrically connecting a pin of the electronic actuator to a contact of the PCB, such that the PCB envelops the electronic actuator, thereby forming an electronic module having a side contact through the second electrical contact. Accordingly, the cutting steps of the PCB fabricating process will be removed, therefore the product defects caused by dusts produced during PCB fabrication can be prevented, and the production cost can be reduced. Moreover, the problem of designing circuit layouts on a limited unit area of miniaturized modules can be resolved.

### BRIEF DESCRIPTION OF THE DRAWINGS

FIG. 1A shows a top exploded perspective view of the electronic component and the printed circuit board (PCB).

FIG. 1B shows a bottom exploded perspective view of the electronic component and the printed circuit board (PCB).

FIG. 2 is a perspective showing the assembly of the electronic component and the printed circuit board (PCB).

FIG. 3 is a perspective view showing the method of fabricating an electronic module having a side contact made according to the present invention.

FIG. 4A is a schematic view showing the method of fabricating an image sensor component.

FIG. 4B is a schematic view showing the method of fabricating an image sensor component.

FIG. 4C is a schematic view showing the method of fabricating an image sensor component.

FIG. 4D is a schematic view showing the method of fabricating an image sensor component.

### DETAILED DESCRIPTION OF THE INVENTION

The present invention will be fully described with preferred embodiments and accompanying drawings. It should be understood beforehand that any person familiar with the skill is able to make modification to the invention described and attain the same effect, and that the description below is a general representation to people familiar with the skill and should not be construed as a limitation on the actual applicable scope of the present invention.

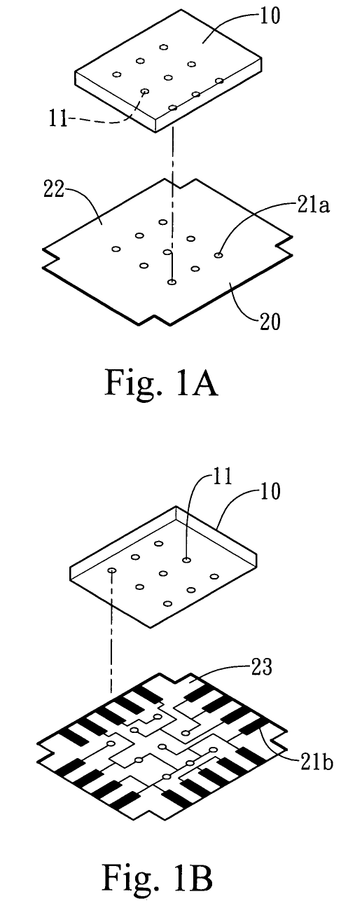

Referring to FIG. 1A and FIG. 1B are the top and button exploded perspective view of the electronic component and the printed circuit board (PCB). The present invention provides an electronic actuator 10 of an electronic module and a flexible printed circuit board (PCB) 20. The electronic actuator 10 includes a plurality of pins 11, whereas the flexible PCB 20 includes a first surface 22 and a second surface 23. The first surface 22 includes a plurality of first electrical contacts 21a corresponding to a plurality of pins 11 of the electronic actuator 10. The second surface 23 includes a plurality of second electrical contacts 21b configured and connected to the first electrical contacts 21a, whereas the second electrical contact 21b includes pins for circuit layout on the second surface 22 of the PCB 20.

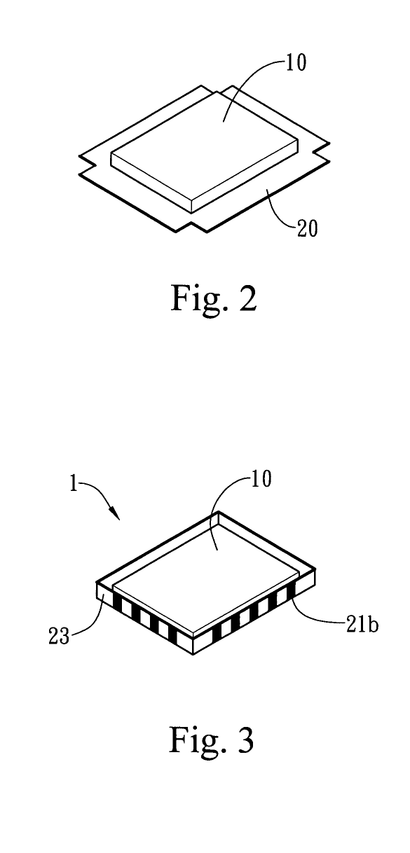

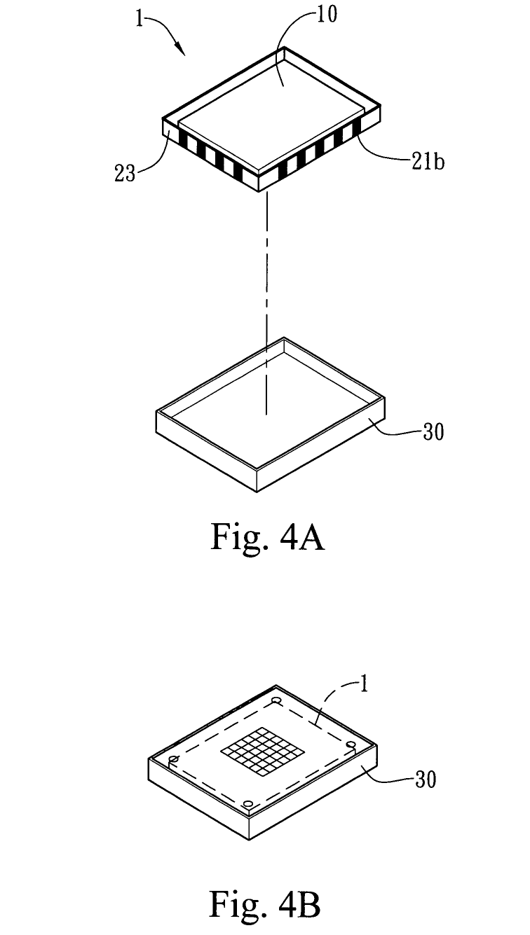

Referring to FIG. 2 and FIG. 3 are perspectives showing the assembly of the electronic component and the printed circuit board (PCB), and the method of fabricating an electronic module having a side contact made according to the present invention. Each of the pins 11 of the electronic actuator 10 is electrically connected to each of the first electrical contacts 21a on the first surface 22 of the PCB 20, with an edge of at least a side of the second surface 23 of the PCB 20 bending to the first surface 22, thereby forming an electronic module 1 having a side contact through the second electrical contact 21b.

The method disclosed in the present invention can be applied to the method of fabricating image sensor modules, and leads to obvious outstanding performance. The present invention first provides an electronic actuator 10, which is an image chip. The image chip includes a plurality of the pins 11, and the flexible PCB 20 includes a first surface 22 and a second surface 23. The first surface 22 includes a plurality of first electrical contacts 21a corresponding to a plurality of pins 11 of the electronic actuator 10, whereas the second surface 23 includes a plurality of second electrical contacts 21b configured and connected to the plurality of first electrical contacts 21a. The second electrical contact 21b has pins available for designing layout on the second surface 22 of the PCB 20.

It is to be noted that the PCB 20 is cross-shaped, and four sides of the PCB 20 are bended to the first surface 22 with a right angle to envelop the image chip, thereby an image module having a side contact will be formed through the layout of the second electrical contact 21b.

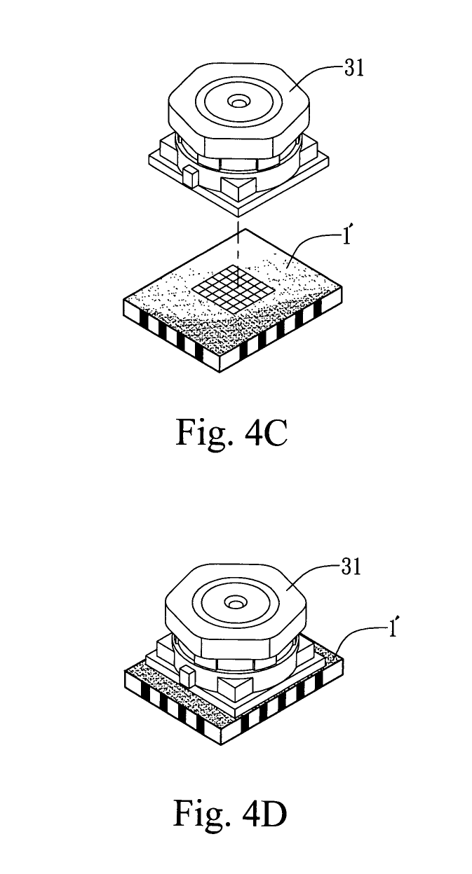

Referring to FIG. 4A to FIG. 4D are the schematic views showing the method of fabricating an image sensor component. According to the embodiment, a method of fabricating an image sensor module applies the method disclosed in the present invention. Wherein the image sensor module 1 is placed in a mold 30, then the mold 30 is removed after stuffing is added to the mold to form an image sensor module 1′ and install the lens module 31. Accordingly, the cutting steps of the PCB fabricating process will be removed, therefore the production cost can be reduced, the problem of designing circuit layouts on a limited unit area of miniaturized modules can be resolved, and the image sensors can be made smaller and thinner.

It is to be noted that the PCB 20 can be designed into T-shaped or L-shaped, depending on the needs of designers, in order to save materials and lower production costs. Also, the circuit designer can decide which side of the PCB 20 to be bent to the first surface 22 so as to envelop the electronic actuator 10.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A method of fabricating an electronic module having a side contact, at least comprising:
providing a printed circuit board (PCB), with a first surface thereof having a first electrical contact as well as a second surface thereof forming a layout of a second electrical contact such that said first electrical contact connects to said second electrical contact;
providing an electronic actuator, having a pin thereof electrically connected to said first electrical contact on said first surface of said PCB; and
bending an edge of at least one side of said PCB to said first surface, thereby forming an electronic module having a side contact through said layout of said second electrical contact.

2. The method of fabricating an electronic module having a side contact as claimed in claim 1, wherein said electronic actuator is an image chip.

3. The method of fabricating an electronic module having a side contact as claimed in claim 1, wherein said PCB is a printed circuit board made of soft materials.

4. The method of fabricating an electronic module having a side contact as claimed in claim 1, wherein said PCB is cross-shaped, and four sides of said PCB are bended to said first surface to envelop said electronic actuator, thereby an electronic module having a side contact will be formed through the layout of said second electrical contact.

5. The method of fabricating an electronic module having a side contact as claimed in claim 1, wherein said PCB is T-shaped, and at least one side of said PCB is bended to said first surface, thereby an electronic module having a side contact will be formed through the layout of said second electrical contact.

6. The method of fabricating an electronic module having a side contact as claimed in claim 1, wherein said PCB is L-shaped, and at least one side of said PCB is bended to said first surface, thereby an electronic module having a side contact will be formed through the layout of said second electrical contact.
